(19) United States
(12) Patent Application Publication
(10) Pub. No.: US 2004/0060432 A1
(43) Pub. Date: Apr. 1, 2004

(54) Brake booster

(76) Inventors: Juan Simon Bacardit, Barcelone (ES); Fernando Sacristan, Barcelone (ES)

Correspondence Address: Leo H. McCormick Jr., 2112 Mishawaka Avenue, P.O. Box 4721, South Bend, IN, 46634, US

(21) Appl. No.: 10/674,218

(22) Filed: Sep. 29, 2003

(30) Foreign Application Priority Data
Sep. 12, 2002 (FR) 02/11340

(51) Int. Cl. F15B 9/10

(52) U.S. Cl. 91/376 R

(57) ABSTRACT

A method for manufacturing a brake booster and a device for implementing the a method. The booster comprises an envelope in which there is mounted to slide with sealing a skirt dividing a low-pressure chamber from a variable-pressure chamber, a piston, a three-way valve (19) comprising a plunger distributor (20) formed of a feeler (22) slidably surrounded by a bushing (32) forming part of an emergency brake boosting device. The device also comprises a key for axially indexing the bushing relative to the piston and able to collaborate with a stop means (114) of the bushing for a rate of travel (V) of the distributor above a rate of activation (Vs) allowing the jump to be altered. The bushing (102) according to the invention comprises at least one adjusting means (120) for adjusting the axial position of the stop means relative to the longitudinal ends (101, 103) of the bushing, thus in part determining the activation rate (Vs).

Brake booster comprising an emergency braking device, method for adjusting a threshold rate of activation of said device and device for implementing said method.

The present invention relates mainly to a pneumatic brake booster comprising an emergency brake boosting device, to a method for adjusting a threshold rate of activation of said brake boosting device and to a device for implementing said adjusting method, and more particularly to a method for setting a predetermined rate of travel of a first element associated with an actuating rod with respect to a second element formed by a pneumatic piston of the pneumatic brake booster, beyond which a brake boosting device is activated.

A booster of known type comprises an envelope formed by two shells delimiting a sealed interior volume in which there is mounted to slide with sealing a skirt dividing the interior volume into a low-pressure chamber and a variable-pressure chamber, the skirt in its central part houses a pneumatic piston moving with the skirt, the piston being equipped with a three-way valve actuated by an actuating rod connected to a brake pedal. The three-way valve at rest places the low-pressure chamber and the variable-pressure chamber in communication, and, when there is action on the brake pedal, isolates the low-pressure chamber and supplies the variable-pressure chamber with a pneumatic fluid at high pressure, for example with air at atmospheric pressure.

The booster also comprises an emergency brake boosting device described in unpublished Patent Application FR 01/07017 filed on 25 May 2001, allowing an increase in the booster jump during an emergency braking phase. The device is arranged at the three-way valve, the three-way valve comprising a composite plunger distributor able to come into contact with a reaction disk transmitting the reaction of a hydraulic brake circuit boosted by the booster to the driver via the actuating rod and the brake pedal. The plunger distributor is to be composite because it comprises a central first element bearing a first valve seat of the three-way valve, at rest isolating the variable-pressure chamber from the high-pressure environment. The distributor also comprises a second element, for example a bushing, surrounding the first element, the bushing comprising on its exterior periphery first means of indexing relative to the body of the pneumatic piston, for example a groove, said groove being able to collaborate with a key resting against the pneumatic piston and locking the bushing in a forward position relative to the central first element and thus increasing the booster jump.

The locking of the key on the bushing occurs for a rate of travel of the plunger distributor with respect to the key, and more generally with respect to the pneumatic piston, that exceeds a predetermined rate.

This threshold rate is determined by the longitudinal dimensions of the booster and also by the longitudinal dimensions of the bushing, and so great precision is required when manufacturing the elements of which the plunger distributor is made. Now, because of the small size of the elements of which a pneumatic brake booster three-way valve is made, the precision required on the dimensions is very difficult to achieve using existing methods that can currently be applied to mass production while at the same time maintaining a reasonable cost price in order to obtain a booster equipped with an emergency brake boosting device that can be applied to a wide range of motor vehicles.

In addition, mass production of a bushing of the appropriate dimensions is not conceivable and it is therefore necessary to anticipate individual adjustment at the time of mounting the emergency brake boosting device.

It is therefore one object of the present invention to offer a method of adjusting a threshold rate of activation of a brake boosting device for a pneumatic brake booster that is simple and readily applicable to mass production.

Another object of the present invention is to offer a method for adjusting a threshold rate of activation of a brake boosting device for a pneumatic brake booster that requires very little by way of modification to the geometry of the elements of which the emergency brake boosting device is made.

Another object of the present invention is to offer a pneumatic brake booster equipped with an emergency brake boosting device that has great activation precision.

Another object is to offer a pneumatic brake booster equipped with an emergency brake boosting device that is of a reasonable cost price.

These objects are achieved through a method allowing adjustment, at the time of mounting, and individually, of the longitudinal dimensions of the bushing of the pneumatic brake booster, particularly the position of the stop relative to the end of the bushing likely to come into contact with the reaction disk.

In other words, it involves positioning the stop of the locking key borne by the bushing of the plunger distributor individually by longitudinal translation of the longitudinal ends of the bushing or by longitudinal translation of the stop, for example by plastic deformation of deformable parts of the bushing or by fixing after positioning of the stop by the key borne by the bushing.

The present invention also has as its subject a pneumatic brake booster comprising an envelope with longitudinal axis in which there is mounted to slide with sealing a skirt dividing a low-pressure chamber from a variable-pressure chamber, a pneumatic piston of longitudinal axis mounted securely in a central orifice of the skirt, said piston comprising a rear tubular part in which there is arranged a three-way valve actuated by an actuating rod connected to a brake pedal, said three-way valve comprising a plunger distributor formed by a central feeler and a bushing, said bushing forming part of an emergency brake boosting device and being mounted to slide around the central feeler, said device also comprising a key for axially indexing the bushing relative to the pneumatic piston of the booster, said bushing comprising a stop means able to collaborate with part of the key for a rate of travel of the distributor above a predetermined rate of activation, said key, in the case of emergency braking, keeping the bushing in a forward position relative to the central feeler to modify the jump of said booster and the reaction transmitted to the brake pedal, characterized in that the bushing comprises at least one adjusting means for adjusting the axial position of the stop means relative to a first and a second longitudinal end of the bushing and in part fixing the activation rate.

Another subject of the present invention is a booster characterized in that the stop means comprises an annular projection formed as an integral part of the bushing body.

Another subject of the present invention is a booster characterized in that the bushing comprises a first and a second section arranged between the stop means and the second longitudinal end of the bushing and in that the first section can be plastically deformed under a load lower than the load needed to plastically deform the second section.

Another subject of the present invention is a booster characterized in that the second section has a roughly ellipsoidal longitudinal section.

Another subject of the present invention is a booster characterized in that the stop means is formed by an annular projection forming a first rest means able to collaborate with a device used to manufacture said booster.

Another subject of the present invention is a booster characterized in that the bushing comprises a third and a fourth section which is arranged between a second rest means formed by a shoulder on the exterior periphery of the bushing and the first longitudinal end of the bushing and in that the third section can be plastically deformed under a load lower than the load needed to plastically deform the fourth section.

Another subject of the present invention is a booster characterized in that the second rest means forms, with the stop means, an annular groove, said second rest means being able to collaborate with a device used to manufacture said booster.

Another subject of the present invention is a booster characterized in that the third section comprises a sleeve tube of smaller thickness relative to the thickness of the sleeve tube that forms the fourth section.

Another subject of the present invention is a booster characterized in that the stop means comprises an annular ring attached to the bushing body.

Another subject of the present invention is a booster characterized in that the stop means comprises means of attachment by crimping to the bushing body.

Another subject of the present invention is a booster characterized in that the means of attachment comprises a sleeve tube running axially from the internal periphery of the ring.

Another subject of the present invention is a booster characterized in that the annular ring is fixed by welding to the bushing body.

Another subject of the present invention is a booster characterized in that the welding is laser welding.

Another subject of the present invention is a device for manufacturing a booster according to the present invention, characterized in that it comprises a holding means for axially holding the bushing, a moving means able to move along the longitudinal axis relative to said holding means and able to apply a plastic deformation stress to the bushing body, and a limiting means for limiting the travel of the moving means relative to the bushing body.

Another subject of the present invention is a manufacturing device characterized in that the holding means collaborates with rest means borne by the bushing and respectively forming the rims of an annular groove.

Another subject of the present invention is a manufacturing device characterized in that the moving means comprises an annular shoulder running radially outward and able to collaborate with the means for limiting the travel of the moving means.

Another subject of the present invention is a manufacturing device characterized in that the means for limiting the travel of the moving means comprises a surface for axially indexing the moving means and adjustable spacer means.

Another subject of the present invention is a manufacturing device characterized in that the spacer means comprises at least one washer arranged between the axial indexing surface and the annular shoulder.

Another subject of the present invention is a manufacturing device characterized in that the axial holding means is an annular ring which, during manufacture, rests against the second rest means of the bushing.

Another subject of the present invention is a manufacturing device characterized in that the moving means comprises an annular groove for accommodating the second section of the bushing, said groove being coaxial with the bushing.

Another subject of the present invention is a manufacturing device characterized in that the moving means comprises an internal axial guidance means for guiding said moving means relative to the bushing.

Another subject of the present invention is a manufacturing device characterized in that said internal guidance means comprises a cylindrical bearing surface.

Another subject of the present invention is a manufacturing device characterized in that said guidance means is bordered by the internal periphery of the groove and collaborates with the internal surface of the smaller-diameter second part of the bore made in the bushing.

Another subject of the present invention is a manufacturing device characterized in that the internal axial guidance means is of cylindrical shape and runs axially toward the outside of the body of the moving means.

Another subject of the present invention is a manufacturing device characterized in that it comprises an external guidance means formed by an element of tubular shape slidably accommodating the moving means.

Another subject of the present invention is a manufacturing device characterized in that a first longitudinal end of the tubular-shaped element rests against the fixed holding means that holds the bushing and a second longitudinal end of said tube forms the axial indexing surface.

Another subject of the present invention is a manufacturing device characterized in that it comprises a housing to house the third and fourth sections forming a means for transversely holding the pin.

Another subject of the present invention is a manufacturing device characterized in that said housing comprises a cylindrical cavity of an inside diameter equal to the outside diameter of the fourth section.

Another subject of the present invention is a manufacturing device characterized in that said housing comprises an annular housing forming a rest for the annular ring.

Another subject of the present invention is a manufacturing device characterized in that the axial holding means is an annular ring resting against the second rest means of the bushing.

Another subject of the present invention is a method of manufacturing a booster according to the present invention, characterized in that it comprises at least the steps of:

measuring at least one longitudinal dimension A, B of the bushing involved in the rate of travel value;

comparing the dimension A, B with the value A, B, that is to be achieved;

rejecting the bushing if the measured dimension A, B is less than the value A, BO that is to be achieved; and

altering the position of the axial stop relative to the first and second axial ends of the bushing if the measured dimension A, B is greater than the value A, BO that is to be achieved.

Another subject of the present invention is a method for manufacturing a booster according to the present invention, characterized in that the position of the axial stop is altered relative to the first and second axial end of the bushing by axially deforming part of the bushing using a device for manufacturing a booster according to the present invention.

Another subject of the present invention is a method for manufacturing a booster characterized in that the position of the axial stop relative to the first and second axial end of the bushing is altered by axially deforming part of the bushing using a manufacturing device.

Another subject of the present invention is a manufacturing method characterized in that the position of the axial stop relative to the first and second axial end of the bushing is altered by moving the annular ring relative to the body of the bushing, and in that said ring is immobilized with respect to the bushing body.

Another subject of the present invention is a manufacturing method characterized in that the ring is immobilized by crimping said ring onto the bushing body.

Another subject of the present invention is a manufacturing method characterized in that the ring is immobilized by laser welding said ring onto the bushing body.

The present invention will be better understood with the aid of the description of the attached figures which will follow, for which the front and the rear correspond respectively to the left and to the right in the drawings.

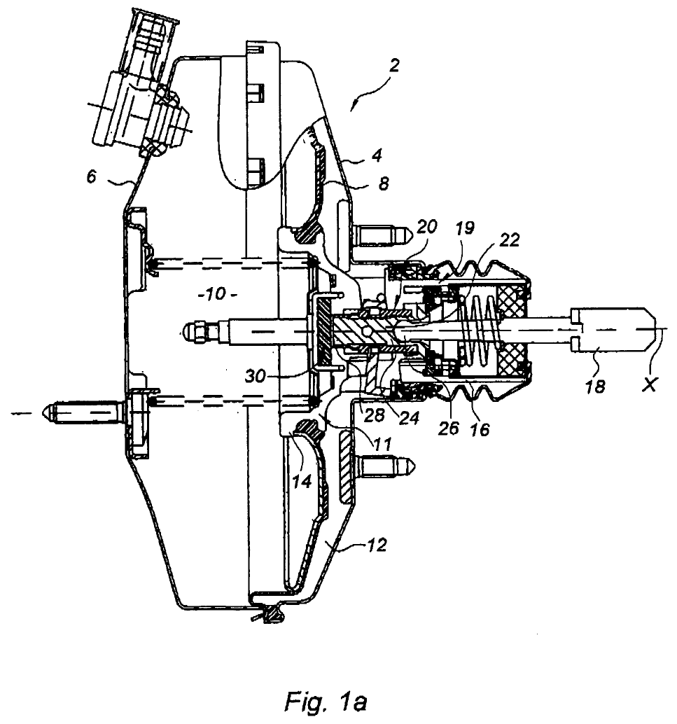

FIG. 1a is a view in longitudinal section of a pneumatic brake booster obtained by a method according to the present invention;

FIG. 1b is a detail view of FIG. 1a;

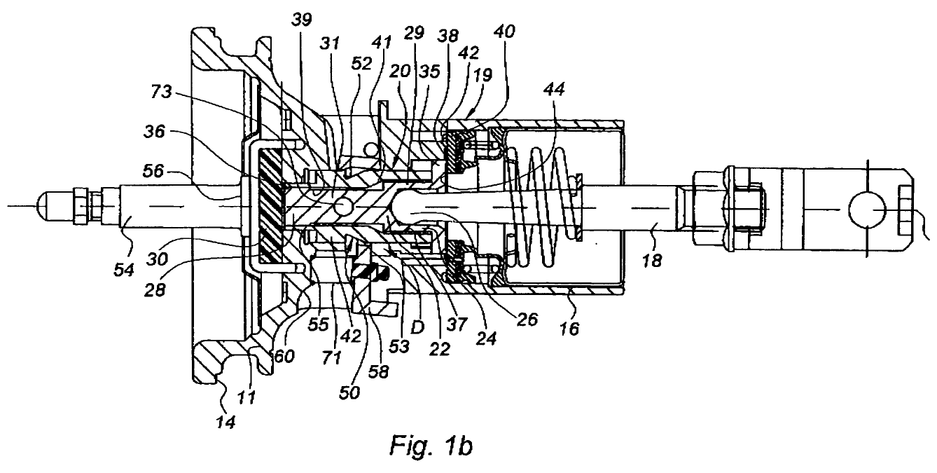

FIG. 2 is a view in longitudinal section of a first exemplary embodiment of an adjustable locking element for the booster according to FIG. 1;

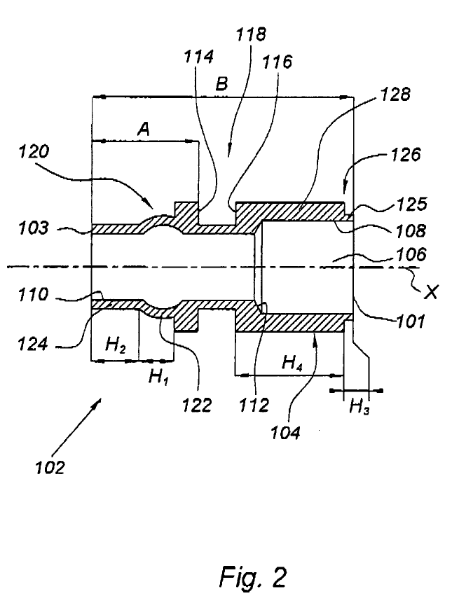

FIG. 3a is a schematic cross-sectional view of a device employing a first step of the method according to the present invention applied to the locking element of FIG. 2;

FIG. 3b is a schematic cross-sectional view of a device employing a second step of the method according to the present invention applied to the locking element of FIG. 2;

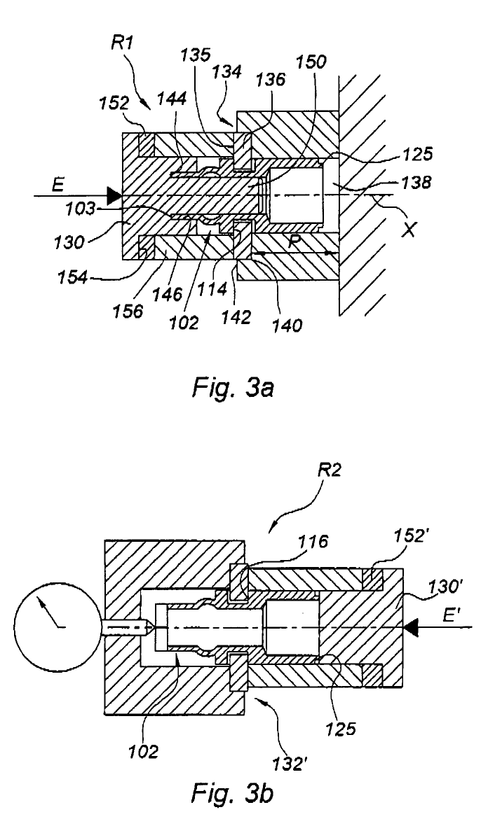

FIG. 4 is a view in section of a first example of a second embodiment of the locking element; and

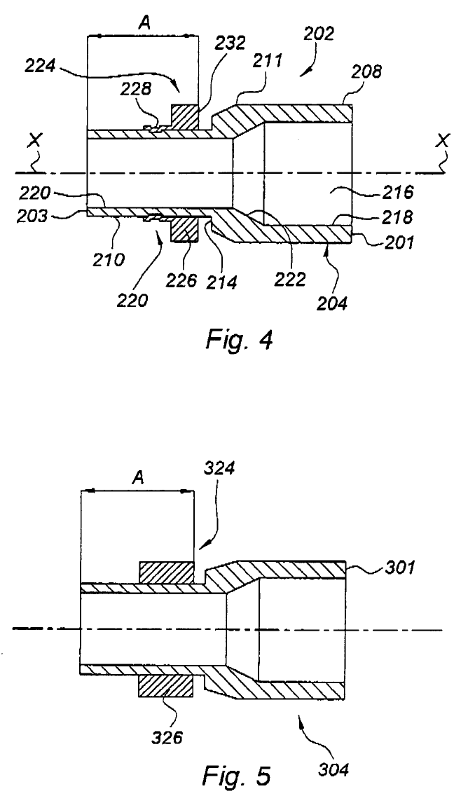

FIG. 5 is a view in section of a second example of the second embodiment of a locking element.

All the elements of the booster according to the present invention have the longitudinal axis of the booster as their axis of revolution.

FIG. 1 shows a booster of known type of longitudinal axis X comprising an envelope 2 formed of a first shell 4 and a second shell 6 and in which there is mounted to slide with sealing a skirt 8 dividing the interior volume defined by the envelope 2 into a low-pressure first chamber 10 and a variable-pressure second chamber 12.

The skirt 8 comprises in its central part a pneumatic piston 11 mounted with sealing on the skirt via its radially external end 14 directed forward and running longitudinally rearward in the form of a sleeve tube 16 comprising a three-way valve 19 actuated by an actuating rod 18 connected to a brake pedal (not depicted).

The three-way valve 19 is equipped with a plunger distributor 20 of axis X comprising a central feeler 22 equipped with a rear first longitudinal end 24 connected to a front end of the actuating rod by a swiveling connection 26 and a front second longitudinal end 28 at the opposite end to the first longitudinal end 24 and able to come into contact with a more or less incompressible reaction disk 30.

The feeler 22 comprises, at its rear first longitudinal end 24, a base 35 connected to a larger-diameter first part 29 of axis X, and connected to a smaller-diameter second part 31 of axis X by a cone frustum 33 directed forward and of axis X.

FIG. 1b shows that the three-way valve also comprises a first and a second valve seat 38, 40, these being borne respectively by the rear longitudinal end 24 of the plunger 22 and by a shoulder 42 made on the interior periphery of the sleeve tube 16 of the pneumatic piston 11. The first valve seat 38 is formed of an annular bulge projecting from a rear annular face 44 of the rear end 24 of the plunger 22 and the second valve seat 40 is formed by an annular bulge projecting from the shoulder 42.

As the structure of a three-way valve is well known to those skilled in the art, we shall not describe it further in detail.

The plunger distributor also comprises a bushing 32 the axis of which is coaxial with the axis X, forming part of an emergency brake boosting device D and surrounding the plunger 20 and resting via a rear longitudinal end 34 against the base 35 of the plunger 22 and able to come into contact via a front longitudinal end 36 with the reaction disk 30. The bushing 32 of known type is pierced with a bore comprising, on its interior periphery, a first part 37 of larger inside diameter, connected to a second part 39 of smaller inside diameter by a cone frustum 41 facing rearward and respectively surrounding the larger-diameter first part 29, the smaller-diameter second part 31 and the cone frustum 33 of the feeler 22.

The bushing 32 also comprises, on its exterior surface, a stop means, in the example depicted this is a groove 50, advantageously a first side 52 of the groove 50 facing forward is roughly perpendicular to the axis X, and a second side 53 directed rearward and making an angle that is not a right angle with the axis X. It is, however, conceivable to envisage a stop means attached to the body of the bushing.

The bushing 32 also comprises, at one longitudinal end, a means 55 for pressing said bushing against the reaction disk 30, this means being formed of a small-thickness tubular part.

The braking force provided by the driver via the feeler 22 and the boosting provided by the booster via the pneumatic piston 11 are transmitted to a master cylinder (not depicted) by means of a push rod 54 and of the reaction disk 30 made of a more or less incompressible material arranged in a housing fixed at a rear first longitudinal end 56 of the push rod 22, the second longitudinal end of the push rod 54 collaborating with a piston of the master cylinder (not depicted).

The emergency brake boosting device also comprises a key 58 for longitudinally indexing the bushing 32 relative to the pneumatic piston 11. The key is mounted in the body of the pneumatic piston 11 inside a slot 60 roughly perpendicular to the axis X so that it can tilt about an axis Y perpendicular to the axis X and lying in a mid-plane P orthogonal to the sheet of the drawing. The key for axially indexing the bushing will be described quickly because it is known to those skilled in the art and comprises a key body pierced with a central orifice and equipped at an upper first longitudinal end with a head roughly perpendicular to the key body and able to collaborate with the groove 50 of the bushing 32 and at a lower second longitudinal end with a lug roughly perpendicular to the key body and resting, at rest, against the body of the booster and allowing the emergency brake boosting device to be unlocked at the end of a braking phase.

An elastic means 71, for example a cylindrical spring, is mounted in compression in the slot 60 roughly parallel to the axis X in compression between the body of the pneumatic piston 11 and the body of the key 58.

A pin 73 is mounted to pass through more or less perpendicular to the axis X in the plunger distributor, such that it is fixed in the feeler and floats in the bushing in an oblong passage (not depicted).

We shall now explain the way in which the booster and in particular the emergency brake boosting device, works.

Under normal braking, the driver moves the actuating rod 18 by depressing a brake pedal at a rate lower than a threshold rate Vs, moving toward the reaction disk 30 the plunger distributor 20 formed of the feeler 22 and the bushing 32. The communication between the low-pressure chamber (10) and the variable-pressure chamber (12) is therefore closed and air at atmospheric pressure is supplied to the variable-pressure chamber 12. The pressure difference across the two chambers 10, 12 causes the pneumatic piston to move and begins to boost the braking. In this configuration, the key 58 is not locked onto the bushing 32. At the end of braking, that is to say as the actuating rod 18 retreats, the supply of air at atmospheric pressure to the variable-pressure chamber 12 is interrupted and the communication between the two chambers 10, 12 is opened again, allowing the piston to retreat.

Under emergency braking, that is to say when the rate of travel V of the plunger distributor crosses the threshold rate Vs, the bushing moves relative to the piston by sufficient travel for the head 62 of the key 58 to enter the groove 50 and lock the bushing in a forward position in the reaction disk 30. If the driver partially relaxes his force on the pedal, as has been observed in most emergency braking situations, the feeler 22 retreats although the bushing remains pressed against the reaction disk 30 and continues the braking effort. There is then a change in the value of the booster jump, because the penetration of the bushing in the reaction disk has appreciably altered the clearance between the central feeler 22 and the surface of the reaction disk 30 against which the feeler 20 is able to come into contact. Furthermore, the hydraulic reaction from the master cylinder is transmitted to the brake pedal is via the distributor 20 is reduced as an additional part of the reaction is actually transmitted to the pneumatic piston 11 via the bushing 32 which, during emergency braking, moves as one with the pneumatic piston 11. At the end of braking, the feeler retreats far enough for the communication between the two chambers 10, 12 to open again, causing the retreat of the piston 11; the key 58 and the bushing 32 retreat, and the key 58, by means of the lug, comes to rest against the body of the booster causing the key 58 to be unlocked from the bushing 32. The bushing 32 returns to its rest position resting against the base 35 of the feeler by means of the pin 73.

However, in order to be able to set Vs, it is necessary to have a bushing allowing individual adjustment of the longitudinal dimension of the bushing, and this is what the present invention proposes. FIG. 2 shows a bushing 102 according to a first embodiment of the present invention, of axis X, comprising a roughly cylindrical body 104 of axial dimension B between a rear first longitudinal end 101 and a front second longitudinal end 103. The body 104 is pierced by a bore 106 passing coaxially through the bushing body 104 formed of a larger-diameter first part 108 connected to a smaller-diameter second part 110 by a cone frustum 112 facing forward. The bushing 102 on its exterior surface, advantageously roughly equidistant from each of the axial ends of the bushing body 104, has first and second separate rest means 114, 116 facing each other and delimiting an annular groove 118 on the exterior periphery of the bushing able to collaborate with devices for adjusting the axial dimensions of the bushings. The first rest means 104 arranged forward of the second rest means 116 forms a stop means able to collaborate with the longitudinal indexing key.

The bushing body 104 comprises, forward of the stop means 114, a first and a second means 120, 126 of adjusting the rate of activation Vs of the brake boosting device. The first adjusting means 120 in particular allows the distance A separating the stop 114 from the front longitudinal end of the bushing 102 to be set to a given length.

The first adjusting means 120 comprises a first longitudinal section 122 of axial dimension H1, a second longitudinal section 124 of axial dimension H2 arranged forward of the first section 122 so that H11+H2=A. The first section 122 can be plastically deformed for a stress level higher than a predetermined first value C1 but lower than a value C2 that will allow the second section 124 to be deformed. In the example depicted, the first section 122 is of roughly elliptical longitudinal section. However, it is conceivable, to provide for example a first section 122 of smaller thickness relative to the thickness of the second section 124 allowing the first section 122 to be deformed at a lower stress by comparison with the second section 124.

The second adjusting means 126 for adjusting to a given length allows the longitudinal distance C separating the rear end 101 of the bushing 102 and the second rest means 116 to be adjusted. The second adjusting means 126 in the example depicted comprises a third section 125 of smaller thickness arranged at the rear longitudinal end of the body 104 of axial dimension H3 and a fourth section 128 of greater thickness connecting the second rest means 116 and the second adjusting means 126 and of axial dimension H4. The third section 125 can be plastically deformed for a deformation stress C3 lower than a stress C4 needed to deform the fourth section 128. Of course, the second adjusting means 126 may be arranged differently between the second rest means 116 and the rear longitudinal end of the bushing body. Of course, the third section 126 may have a particular shape likely to facilitate plastic deformation, for example a shape similar to that of the first adjusting means 120.

The bushing 102 forms part of a brake boosting device G1 like the one depicted in FIG. 1 and is able to collaborate with an indexing key as described.

The threshold rate Vs of activation of the boosting device G1 corresponding to a rate of travel of the bushing 132 with respect to the pneumatic piston 11 and to the key 58 is determined in part by the distance B or total axial dimension of the bushing separating the rear longitudinal end 101 of the bushing 102 from its front longitudinal end 103 and the distance A separating the front longitudinal end of the bushing and the first rest means 114. In consequence, adjusting the dimension A to a target value A0 by altering the dimension H1 of the portion 122 using the first adjusting means 120 and setting the dimension C to a target value C0 by altering the dimension H3 of the portion 125 using the second adjusting means 126, and therefore setting the dimension B to a target value B0 allow the rate of activation Vs to be set.

FIGS. 3a and 3b show the devices for adjusting the dimensions A and B and, in particular, the dimensions H1 and H3. In particular, FIG. 3a shows a first adjusting device R1 for adjusting the dimension A, comprising a means 130 able to move in translation along the axis X able to apply a stress E in the direction of the arrow, an axial stop means 132 for the moving means 130 and a means 134 for axially indexing the bushing. The axial indexing means 134 comprises a rest surface 135 able to collaborate with the first rest means 114 borne by the bushing 102. The rest surface 135 is advantageously of annular shape improving the stability of resting and is, for example, borne by an annular ring 136 of an inside diameter roughly equal to the inside diameter of the annular ring 118. Of course, the annular ring 136 is of a shape tailored to allow it to fit into the groove 118, for example it may advantageously be made as two separable elements.

In the embodiment depicted, the second adjusting means 126 are housed in a cavity 138 of roughly cylindrical shape advantageously comprising an annular housing 140 on a front longitudinal face 142 of the cavity 138 and forming means of centering the rest ring relative to the bushing 102. The axial dimension along the axis X of the cavity 138 or depth P is greater than or equal to the sum of the axial dimensions of the second adjusting means 126, H3+H4, so as to avoid deformation of the third section 125 during a phase of adjusting the dimension A, i.e. P≧H3+H4.

The moving means 130 comprises an application surface 144 for applying to the front longitudinal end 103 of the bushing 102 a stress for deforming the first section, the surface 144 advantageously being formed by the bottom of an annular groove 146 made in a rear longitudinal face 148 of the moving means 130. The groove 146 also forms a housing to accommodate the second section 124, improving the transverse holding of the bushing as the moving means 130 moves. The groove 146 advantageously has an outside diameter equal to the outside diameter of the second section 124, and an inside diameter equal to the inside diameter of the second section 124.

The moving means 146 also advantageously comprises an axial guidance means 150 for guiding the movement of the moving means 130 relative to the bushing 102. The guidance means 150 is advantageously formed by a cylindrical bearing surface running axially from the rear face of the moving means 130 and bordered by the annular groove 146. The cylindrical bearing surface 150 enters the bore 106 as the bushing is mounted in the adjusting device, the periphery of the cylindrical bearing surface 150 being of an outside diameter equal to the inside diameter of the smaller-diameter part 110. Of course, a guidance means 150 of some form other than cylindrical, for example with a Y-shaped or cross-shaped cross section could be provided, the ends of the branches coming to rest against the internal surface of the smaller-diameter part 110.

The definition of the first section 122 is determined by the relative movement of the moving means 130 and of the bushing 102, the movement being limited by a stop 152, for example spacer means arranged in the embodiment between the rest ring 136 and an annular shoulder 154 of the moving means 130 extending radially toward the outside of the front longitudinal end of the moving means 130.

The spacer means are, for example, formed of at least one washer, advantageously several washers stacked up according to the desired relative movement between the moving means 130 and the bushing 102.

The device for adjusting the dimension A also advantageously comprises an external axial guidance means 156 for guiding the moving means 130, for example a tube in which the moving means is able to slide and the exterior surface of which collaborates with the interior of the surface of the tube. The tube 156 is arranged resting against the annular ring 136 and advantageously forms a rest for the spacer means. Of course, it is conceivable for example to provide a fixed deformable element 130 and a means 134 for axially indexing the bushing which would itself be able to move and would move the bushing 102 toward the deforming means 130 or even to provide means 130 and 134 that move closer to one another.

We shall explain the adjusting of the dimension A of the bushing 102 by altering H1.

The ring 136 is mounted around the bushing 102 in the groove 118, then the bushing 102 is mounted in the cavity 138 by sliding of the second adjusting means 126 until the ring 138 comes to rest in the annular housing 140. The tube 156 is then arranged around the bushing 102 and finally the cylindrical bearing surface 150 of the moving means enters the bushing, the spacer means being mounted against the annular shoulder 154. Then, a load E is applied along the axis X to the moving means 130 in the direction of the arrow until the spacer means 150 come into abutment against the front longitudinal end of the tube 156.

FIG. 3b shows a second adjusting device R2 for adjusting the dimension C, which is embodied in a very similar way to the device for adjusting the dimension A, and so we shall not describe it in detail. The device R2 comprises a moving means 130′ able to move axially coming into contact with the rear longitudinal end 101 of the bushing to plastically deform the third section 125 by movement in the opposite direction to the arrow, a means 132′ for axially immobilizing the bushing 102 in the opposite direction to the arrow by collaboration with the second rest means 116 and means 152′ for limiting the axial movement of the moving means 130′, for example spacer means collaborating with an annular shoulder of the moving means and arranged at its rear longitudinal end. Of course, it is conceivable to provide guidance means for axially and transversely guiding the moving means relative to the bushing that avoid unwanted deformation of the bushing.

The way in which the adjusting device R2 for adjusting the dimension C works is the same as the way in which the adjusting device for adjusting the dimension A works.

The method for setting the threshold rate Vs comprises, amongst others, the following steps:

measuring the longitudinal dimensions A, B of the bushing involved in the rate of travel value;

comparing the dimensions A, B with the respective values A0, B0 that are to be achieved; and

rejecting the bushing if the measured dimensions A, B are lower than the respective values A0, B0 that are to be achieved.

If the dimension A is higher than the value A0 to be achieved, determining the thickness of spacer needed to achieve the value A0 if A is different from A0; plastically deforming the second section 122 to modify its axial dimension H1 to achieve the dimension A0 by moving the moving means 130 in the direction of the arrow until the moving means 130 comes into abutment against the spacer means 152.

If the dimension B is greater than the value B0 that is to be achieved, determining the thickness of spacer needed for the desired value B0 if B is different from B0; plastically deforming the third section 125 to modify its axial dimension H3 by moving the moving means 130′ in the opposite direction to the arrow until the moving means 130′ comes into abutment against the spacer means.

Of course, it would be possible to anticipate just one of the two adjusting means 120, 126, depending on the dimension A, B that needs to be adjusted.

FIG. 4 shows a first example of a second embodiment of a bushing according to the present invention forming part of an emergency brake boosting device described in FIG. 1. The bushing 202 comprises a roughly cylindrical body 204 with a rear first longitudinal end 201 and front second longitudinal end 203, which is formed of a first part of larger outside diameter 208 facing to the rear and a second part of smaller outside diameter 210 facing forward. The larger-diameter first part 208 advantageously comprises, at a front first longitudinal end 212, a portion in the form of a cone frustum 211 facing rearward, meeting the second part 210 at a shoulder 214 running radially outward, this cone frustum portion facilitating the mounting of the bushing around the feeler during booster manufacture.

The body 204 of the bushing is pierced with a stepped throughbore 216 comprising, toward the rear, a first part of larger inside diameter 218 and a second part of smaller inside diameter 220 toward the front, these advantageously being joined together by a cone frustum portion 222 with its vertex directed toward the rear, and advantageously with the same cone angle as the cone frustum portion 211.

The bushing 202 also comprises a first stop means 224 distant from the front second longitudinal end 203 by a distance A, the stop means 224 formed by a rest surface 232 is able to collaborate with a locking key as described before. The first stop means 224 comprises an annular ring 226 forming first adjusting means 220 for adjusting the distance A to a target value A0, the ring 226 is advantageously of rectangular cross section with an inside diameter equal to the outside diameter of the second part, of smaller outside diameter, 214, and a fixing means 228 formed for example of a sleeve tube formed as an integral part of the ring 226 and running axially from the internal periphery of the ring forward and of an inside diameter equal to the outside diameter of the second part of smaller outside diameter 214. The stop means 224 is fixed to the bushing body 204 by crimping, particularly by plastic deformation of the sleeve tube 230 so that the rest surface 232 of the ring 226 is situated axially at a predetermined distance A.

FIG. 5 shows a second example of the second embodiment of the bushing according to the present invention. References increased by 100 over the references used for FIG. 4 are employed for elements that have the same function and more or less the same form.

The stop means 324 comprises an annular ring 326 fixed by welding to the body 304 of the bushing, advantageously by laser welding so as to avoid unwanted dimensional definition of the body of the bushing.

We shall now describe the method for setting the rate of activation of a brake boosting device comprising a bushing according to the second embodiment.

The adjustment method comprises, amongst others, the steps of:

measuring the dimension A;

comparing the value A with the target value A0;

if A is less than A0, rejecting the part;

if A is greater than A0; and

immobilizing, for example by welding or by crimping, the stop means 224, 324 on the body of the bushing.

Of course it is conceivable to provide second adjusting means to make it possible to adjust the distance C separating the stop means 234, 324 from the first longitudinal end 201, 301 to a target value C0, these second adjusting means for example comprise a plastically deformable section like the one borne by the first embodiment of the bushing according to the present invention.

In consequence, the method then comprises the additional steps of measuring the longitudinal dimension of the bushing body and plastically deforming the second adjusting means so as to achieve the desired dimension.

The device for performing adjustment by deforming the second adjusting means is practically the same as the one described in FIG. 3b. Of course it is conceivable to provide a method of manufacture and a device for implementing the said method that allow simultaneous adjustment of both dimensions A and B, and for that it is necessary in particular to provide, for the manufacturing device, a means of axially indexing the bushing in a first direction and in an opposite second direction.

The bushing according to the first and second embodiments are, for example, made of steel, manufactured for example by machining.

We have indeed proposed a simple method of adjusting the threshold rate Vs of activation of the emergency brake boosting device of a pneumatic brake booster.

The present invention applies particularly to the motor industry.

The present invention applies in particular to the motor vehicle braking industry, particularly to the private car braking industry.

We claim:

1. A pneumatic brake booster comprising an envelope with longitudinal axis (X) in which there is mounted to slide with sealing a skirt dividing a low-pressure chamber from a variable-pressure chamber, a pneumatic piston (11) of longitudinal axis (X) mounted securely in a central orifice of the skirt, said piston (11) comprising a rear tubular part in which there is arranged a three-way valve (19) actuated by an actuating rod connected to a brake pedal, said three-way valve comprising a plunger distributor (20) formed by a central feeler (22) and a bushing (32), said bushing forming part of an emergency brake boosting device and being mounted to slide around the central feeler, said device also comprising a key for axially indexing the bushing relative to the pneumatic piston of the booster, said bushing comprising a stop means (114, 224, 324) able to collaborate with part of the key for a rate of travel (V) of the distributor above a predetermined rate of activation (Vs), said key, in the case of emergency braking, keeping the bushing (32) in a forward position relative to the central feeler (22) to modify the jump of said booster and the reaction transmitted to the brake pedal, characterized in that the bushing (102, 202, 302) comprises at least one adjusting means (120, 220, 230, 326) for adjusting the axial position of the stop means relative to a first (101, 201, 301) and a second (103, 203, 303) longitudinal end of the bushing and in part fixing the activation rate (Vs).

2. The booster according to claim 1, characterized in that the stop means (114) comprises an annular projection formed as an integral part of the bushing body.

3. The booster according to claim 2, characterized in that the bushing comprises a first and a second section (122, 124) arranged between the stop means (114) and the second longitudinal end (103) of the bushing (102) and in that the first section (122) can be plastically deformed under a load lower than the load needed to plastically deform the second section (124).

4. The booster according to claim 3, characterized in that the second section (122) has a roughly ellipsoidal longitudinal section.

5. The booster according to claim 4, characterized in that the stop means (114) is formed by an annular projection forming a first rest means able to collaborate with a device used to manufacture said booster.

6. The booster according to claim 5, characterized in that the bushing comprises a third and a fourth section (125, 128) which is arranged between a second rest means (116) formed by a shoulder on the exterior periphery of the bushing and the first longitudinal end (103) of the bushing and in that the third section (125) can be plastically deformed under a load lower than the load needed to plastically deform the fourth section (128).

7. The booster according to claim 6, characterized in that the second rest means (116) forms, with the stop means, an annular groove (118), said second rest means being able to collaborate with a device used to manufacture said booster.

8. The booster according to claim 7, characterized in that the third section (125) comprises a sleeve tube of smaller thickness relative to the thickness of the sleeve tube that forms the fourth section.

9. The booster according to claim 1, characterized in that the stop means (224, 324) comprises an annular ring (226, 326) attached to the bushing body (204, 304).

10. The booster according to claim 9, characterized in that the stop means (224) comprises means of attachment by crimping to the bushing body (204).

11. The booster according to claim 10, characterized in that the means of attachment comprises a sleeve tube running axially from the internal periphery of the ring (226).

12. The booster according to claim 9, characterized in that the annular ring is fixed by welding to the bushing body (204).

13. The booster according to claim 10, characterized in that the welding is laser welding.

14. The booster according to claim 8 wherein during its manufacture it is characterized by holding means (132, 132′) for axially holding the bushing, a moving means (130, 130′) able to move along the longitudinal axis (X) relative to said holding means (132, 132′) and able to apply a plastic deformation stress (F) to the bushing body (122, 125), and a limiting means (152, 152′) for limiting the travel of the moving means (130, 130′) relative to the bushing body (122, 125).

15. The booster according to claim 14, further characterized in that the holding means (132, 132′) collaborates with rest means (114, 116) borne by the bushing and respectively forming the rims of an annular groove.

16. The booster according to claim 15, characterized in that the moving means (130, 130′) comprises an annular shoulder (154, 154′) running radially outward and able to collaborate with the means (152′) for limiting the travel of the moving means (130, 130′).

17. The booster according to claim 16, characterized in that the means (152, 152′) for limiting the travel of the moving means (130, 130′) comprises a surface for axially indexing the moving means (130′) and adjustable spacer means.

18. The booster according to claim 17, characterized in that the spacer means comprises at least one washer arranged between the axial indexing surface and the annular shoulder (154, 154′).

19. The booster according to claim 18, characterized in that the axial holding means (132) is an annular ring which, during manufacture, rests against the second rest means (114) of the bushing.

20. The booster according to claim 19, characterized in that the moving means (130) comprises an annular groove (146) for accommodating the second section (124) of the bushing (102), said groove (146) being coaxial with the bushing.

21. The booster according to claim 20, characterized in that the moving means (130) comprises an internal axial guidance means (150) for guiding said moving means (130) relative to the bushing.

22. The booster according to claim 21, characterized in that said internal guidance means (150) comprises a cylindrical bearing surface.

23. The booster according to claim 22, characterized in that said guidance means (150) is bordered by the internal periphery of the groove (146) and collaborates with the internal surface of the smaller-diameter second part (110) of the bore (106) made in the bushing (102).

24. The booster according to claim 23, characterized in that the internal axial guidance means (150) is of cylindrical shape and runs axially toward the outside of the body of the moving means (130).

25. The booster according to claim 24, characterized in that it comprises an external guidance means (156) formed by an element of tubular shape slidably accommodating the moving means (130).

26. The booster according to claim 25, characterized in that a first longitudinal end of the tubular-shaped element (156) rests against the fixed holding means (132) that holds the bushing and a second longitudinal end of said tube forms the axial indexing surface (152).

27. The booster according to claim 26, characterized in that it comprises a housing to house the third and fourth sections (125, 128) forming a means for transversely holding the pin.

28. The booster according to claim 27, characterized in that said housing comprises a cylindrical cavity of an inside diameter equal to the outside diameter of the fourth section (128).

29. The booster according to claim 28, characterized in that said housing comprises an annular housing forming a rest for the annular ring (146).

30. The booster according to claim 18, characterized in that the axial holding means (132′) is an annular ring resting against the second rest means (116) of the bushing.

31. The booster according to claim 12, wherein during its manufacture it is characterized in that it comprises at least the steps of:
measuring at least one longitudinal dimension (A, B) of the bushing involved in the rate of travel value;
comparing the dimension (A, B) with the value (A0, B0) that is to be achieved;
rejecting the bushing if the measured dimension (A, B) is less than the value (A0, B0) that is to be achieved; and
altering the position of the axial stop relative to the first and second axial ends of the bushing if the measured dimension (A, B) is greater than the value (A0, B0) that is to be achieved.

32. The booster according to claim 31, characterized in that the position of the axial stop is altered relative to the first and second axial end of the bushing by axially deforming part of the bushing.

33. The booster according to claim 31, characterized in that the position of the axial stop relative to the first and second axial end of the bushing is altered by axially deforming part of the bushing.

34. The booster according to claim 31 characterized in that the position of the axial stop relative to the first and second axial end of the bushing is altered by moving the annular ring (226, 326) relative to the body of the bushing (204, 304), and in that said ring (226, 326) is immobilized with respect to the bushing body (204, 304).

35. The booster according to claim 31, characterized in that the ring (226) is immobilized by crimping said ring onto the bushing body (204).

36. The booster according to claim 14, characterized in that the ring (326) is immobilized by laser welding said ring onto the bushing body (304).
